(19) United States
(12) Patent Application Publication
(10) Pub. No.: US 2019/0228308 A1
(43) Pub. Date: Jul. 25, 2019

(54) DEEP LEARNING ACCELERATOR SYSTEM AND METHODS THEREOF

(71) Applicant: ALIBABA GROUP HOLDING LIMITED, George Town (KY)

(72) Inventors: Qinggang ZHOU, San Mateo, CA (US); Lingling JIN, San Mateo, CA (US)

(73) Assignee: ALIBABA GROUP HOLDING LIMITED

(21) Appl. No.: 16/255,744

(22) Filed: Jan. 23, 2019

Related U.S. Application Data
(60) Provisional application No. 62/621,368, filed on Jan. 24, 2018.

(51) Int. Cl. G06N 3/08; G06N 20/00

(52) U.S. Cl. CPC G06N 3/08; G06N 20/00

(57) ABSTRACT

The present disclosure relates to a machine learning accelerator system and methods of transporting data using the machine learning accelerator system. The machine learning accelerator system may include a switch network comprising an array of switch nodes, and an array of processing elements. Each processing element of the array of processing elements is connected to a switch node of the array of switch nodes and is configured to generate data that is transportable via the switch node. The method may include receiving input data using a switch node from a data source and generating output data based on the input data, using a processing element that is connected to the switch node. The method may include transporting the generated output data to a destination processing element using a switch node.

### CROSS REFERENCE TO RELATED APPLICATION

This application is based upon and claims priority to U.S. Provisional Application No. 62/621,368 filed Jan. 24, 2018 and entitled “Deep Learning Accelerator Method Using a Light Weighted Mesh Network with 2D Processing Unit Array,” which is incorporated herein by reference in its entirety.

### BACKGROUND

With the exponential growth on the neural network based deep learning applications across the business units, the commodity central processing unit (CPU)/graphic processing unit (GPU) based platform is no longer a suitable computing substrate to support the ever-growing computation demands in terms of performance, power efficiency, and economic scalability. Developing neural network processors to accelerate neural-network-based deep learning applications has gained significant traction across many business segments, including established integrated chip (IC) manufacturers, start-up companies as well as large Internet companies.

The existing Neural network Processing Units (MPUs) or Tensor Processing Units (TPUs) feature a programmable deterministic execution pipeline. The key parts of this pipeline may include a matrix unit with 256×256 of 8-bit Multiplier-Accumulator units (MACs) and a 24 mebibyte (MiB) memory buffer. However, as the semiconductor technology progresses towards 7 nm node, the transistor density is expected to increase more than 10×. In such configurations, enabling efficient data transfer may require increasing the size of the matrix unit and the buffer size, potentially creating more challenges.

### SUMMARY

The present disclosure relates to a machine learning accelerator system and methods for exchanging data therein. The machine learning accelerator system may include a switch network comprising an array of switch nodes and an array of processing elements. Each processing element of the array of processing elements may be connected to a switch node of the array of switch nodes and is configured to generate data that is transportable via the switch node. The generated data may be transported in one or more data packets, the one or more data packets comprising information related with a location of the destination processing element, a storage location within the destination processing element, and the generated data.

The present disclosure provides a method of transporting data in a machine learning accelerator system. The method may comprise receiving input data from a data source, using a switch node of an array of switch nodes of a switch network. The method may include generating output data based on the input data, using a processing element that is connected to the switch node and is part of an array of processing elements; and transporting the generated output data to a destination processing element of the array of processing elements via the switch network using the switch node.

Consistent with some disclosed embodiments, a computer-readable storage medium comprises a set of instructions executable by at least one processor to perform the aforementioned method is provided.

Consistent with other disclosed embodiments, a non-transitory computer readable storage media may store program instructions, which are executed by at least one processing device and perform the aforementioned method described herein.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates an exemplary deep learning accelerator system, consistent with embodiments of the present disclosure.

FIG. 2 illustrates a block diagram of an exemplary deep learning accelerator system, according to embodiments of the disclosure.

FIG. 3A illustrates an exemplary mesh based deep learning accelerator system, according to embodiments of the disclosure.

FIG. 3B illustrates an exemplary processing element of a deep learning accelerator system, according to embodiments of the disclosure.

FIG. 4 illustrates a block diagram of an exemplary data packet, according to embodiments of the disclosure.

FIG. 5 illustrates an exemplary path for data transfer in a deep learning accelerator system, according to embodiments of the disclosure.

FIG. 6 illustrates an exemplary path for data transfer in a deep learning accelerator system, according to embodiments of the disclosure.

FIG. 7 illustrates an exemplary path for data transfer in a deep learning accelerator system, according to embodiments of the disclosure.

FIG. 8 is a process flow chart of an exemplary method of transporting data in a deep learning accelerator system, according to embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

As indicated above, conventional accelerators have several flaws. For example, the conventional Graphic Processing Units (GPUs) may feature thousands of shader cores with a full instruction set, a dynamic scheduler of work, and a complicated memory hierarchy, causing large power consumption and extra work for deep learning workloads.

Conventional Data Processing Units (DPUs) may feature a data-flow based coarse grain reconfigurable architecture (CGRA). This CGRA may be configured as a mesh of 32×32 clusters and each cluster may be configured as 16 dataflow processing elements (PEs). Data may be passed through this mesh by PEs passing data directly to their neighbours. This may require PEs to spend several cycles to pass data instead of focusing on computing, rendering the dataflow inefficient.

The embodiments of the present invention overcome these issues of conventional accelerators. For example, the embodiments provide a light-weighted switch network, thereby allowing the PEs to focus on computing. Moreover, the computing and storage resources are distributed across many PEs. With the help of 2D mesh connections, data may be communicated among the PEs. Software can flexibly divide the workloads and data of neural network to the arrays of PEs, and programs the data flows accordingly. For similar reasons, it is easy to add additional-resources without increasing the difficulty of packing more work and data.

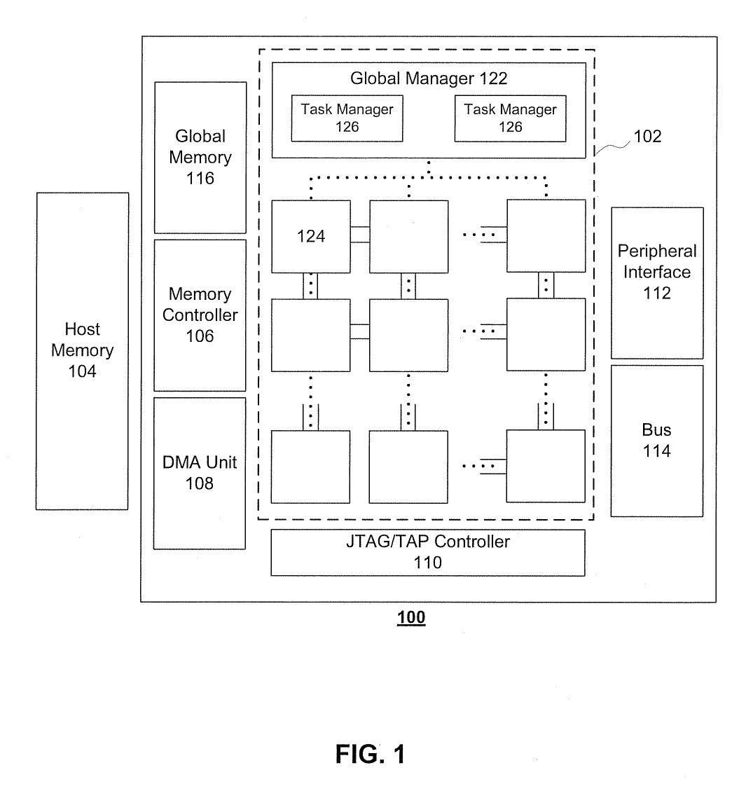

FIG. 1 illustrates an exemplary deep learning accelerator system architecture 100, according to embodiments of the disclosure. In the context of this disclosure, a deep learning accelerator system may also be referred to as a machine learning accelerator. Machine learning and deep learning may be interchangeably used herein. As shown in FIG. 1, accelerator system architecture 100 may include an on-chip communication system 102, a host memory 104, a memory controller 106, a direct memory access (DMA) unit 108, a Joint Test Action Group (JTAG)/Test Access End (TAP) controller 110, a peripheral interface 112, a bus 114, a global memory 116, and the like. It is appreciated that on-chip communication system 102 may perform algorithmic operations based on communicated data. Moreover, accelerator system architecture 100 may include a global memory 116 having on-chip memory blocks (e.g., 4 blocks of 8 GB second generation of high bandwidth memory (HBM2)) to serve as the main memory.

On-chip communication system 102 may include a global manager 122 and a plurality of processing elements 124. Global manager 122 may include one or more task managers 126 configured to coordinate with one or more processing elements 124. Each task manager 126 may be associated with an array of processing elements 124 that provide synapse/neuron circuitry for the neural network. For example, the top layer of processing elements of FIG. 1 may provide circuitry representing an input layer to neural network, while the second layer of processing elements may provide circuitry representing one or more hidden layers of the neural network. As shown in FIG. 1, global manager 122 may include two task managers 126 configured to coordinate with two arrays of processing elements 124. In some embodiments, accelerator system architecture 100 may be referred to as a neural network processing unit (NPU) architecture 100.

Processing elements 124 may include one or more processing elements that each include single instruction multiple data (SIMD) architecture including one or more processing units configured to perform one or more operations (e.g., multiplication, addition, multiply-accumulate, etc.) on the communicated data under the control of global manager 122. To perform the operation on the communicated data packets, processing elements 124 may include a core and a memory buffer. Each processing element may comprise any number of processing units. In some embodiments, processing element 124 may be considered a tile or the like.

Host memory 104 may be off-chip memory such as a host CPU's memory. For example, host memory 104 may be a double data rate synchronous dynamic random-access memory (DDR-SDRAM) memory, or the like. Host memory 104 may be configured to store a large amount of data with slower access speed, compared to the on-chip memory integrated within one or more processor, acting as a higher-level cache.

Memory controller 106 may manage the reading and writing of data to and from a memory block (e.g., HBM2) within global memory 116. For example, memory controller 106 may manage read/write data coming from an external chip communication system (e.g., from DMA unit 108 or a DMA unit corresponding with another NPU) or from on-chip communication system 102 (e.g., from a local memory in processing element 124 via a 2D mesh controlled by a task manager 126 of global manager 122). Moreover, while one memory controller is shown in FIG. 1, it is appreciated that more than one memory controllers may be provided in NPU architecture 100. For example, there may be one memory controller for each memory block (e.g., HBM2) within global memory 116.

Memory controller 106 may generate memory addresses and initiate memory read or write cycles. Memory controller 106 may contain several hardware registers that may be written and read by the one or more processors. The registers may include a memory address register, a byte-count register, one or more control registers, and other types of registers. These registers may specify some combination of the source, the destination, the direction of the transfer (reading from the input/output (I/O) device or writing to the I/O device), the size of the transfer unit, the number of bytes to transfer in one burst, and/or other typical features of memory controllers.

DMA unit 108 may assist with transferring data between host memory 104 and global memory 116. In addition, DMA unit 108 may assist with transferring data between multiple accelerators. DMA unit 108 may allow off-chip devices to access both on-chip and off-chip memory without causing a CPU interrupt. Thus, DMA unit 108 may also generate memory addresses and initiate memory read or write cycles. DMA unit 108 also may contain several hardware registers that may be written and read by the one or more processors, including a memory address register, a byte-count register, one or more control registers, and other types of registers. These registers may specify some combination of the source, the destination, the direction of the transfer (reading from the input/output (I/O) device or writing to the I/O device), the size of the transfer unit, and/or the number of bytes to transfer in one burst. It is appreciated that accelerator architecture 100 may include a second DMA unit, which may be used to transfer data between other accelerator architectures to allow multiple accelerator architectures to communicate directly without involving the host CPU.

JTAG/TAP controller 110 may specify a dedicated debug port implementing a serial communications interface (e.g., a JTAG interface) for low-overhead access to the accelerator without requiring direct external access to the system address and data buses. The JTAG/TAP controller 110 may also have an on-chip test access interface (e.g., a TAP interface) that is configured to implement a protocol to access a set of test registers that present chip logic levels and device capabilities of various parts.

Peripheral interface 112 (such as a PCIe interface), if present, may serve as an (and typically the) inter-chip bus, providing communication between the accelerator and other devices.

Bus 114 includes both intra-chip bus and inter-chip buses. The intra-chip bus connects all internal components to one another as called for by the system architecture. While not all components are connected to every other component, all components do have some connection to other components they need to communicate with. The inter-chip bus connects the accelerator with other devices, such as the off-chip memory or peripherals. Typically, if there is a peripheral interface 112 (e.g., the inter-chip bus), bus 114 is solely concerned with intra-chip buses, though in some implementations it could still be concerned with specialized inter-bus communications.

While accelerator architecture 100 of FIG. 1 is generally directed to an NPU architecture (as further described below), it is appreciated that the disclosed embodiments may be applied to any type of accelerator for accelerating some applications such as deep learning. Such chips may be, for example, GPU, CPU with vector/matrix processing ability, or neural network accelerators for deep learning. SIMD or vector architecture is commonly used to support computing devices with data parallelism, such as graphics processing and deep learning.

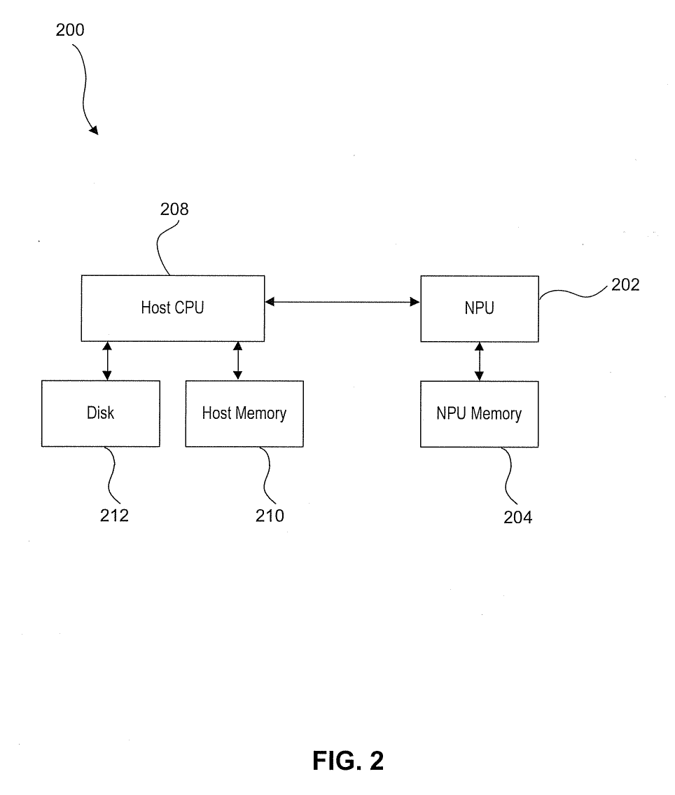

Reference is now made to FIG. 2, which illustrates a block diagram of an exemplary deep learning accelerator system 200, according to embodiments of the disclosure. Deep learning accelerator system 200 may include a neural network processing unit (NPU) 202, a NPU memory 204, a host CPU 208, a host memory 210 associated with host CPU 208, and a disk 212.

As illustrated in FIG. 2, NPU 202 may be connected to host CPU 208 through a peripheral interface (e.g., peripheral interface 112 of FIG. 1). As referred to herein, a neural network processing unit (e.g., NPU 202) may be a computing device for accelerating neural network computing tasks. In some embodiments, NPU 202 may be configured to be used as a co-processor of host CPU 208.

In some embodiments, NPU 202 may comprise a compiler (not shown). The compiler may be a program or a computer software that transforms computer code written in one programming language into NPU instructions to create an executable program. In machining applications, a compiler may perform a variety of operations, for example, pre-processing, lexical analysis, parsing, semantic analysis, conversion of input programs to an intermediate representation, code optimization, code generation, or combinations thereof.

In some embodiments, the compiler may be on a host unit (e.g., host CPU 208 or host memory 210 of FIG. 2), configured to push one or more commands to NPU 202. Based on these commands, a task manager (e.g., task manager 126 of FIG. 1) may assign any number of tasks to one or more processing elements (e.g., processing element 124 of FIG. 1). Some of the commands may instruct a DMA unit (e.g., DMA unit 108 of FIG. 1) to load instructions and data from host memory (e.g., host memory 104 of FIG. 1) into a global memory. The loaded instructions may then be distributed to each processing element 124 assigned with the corresponding task, and the one or more processing elements 124 may process these instructions.

It is appreciated that the first few instructions received by the processing element may instruct the processing element to load/store data from the global memory into one or more local memories of the processing element (e.g., a memory of the processing element or a local memory for each active processing element). Each processing element may then initiate the instruction pipeline, which involves fetching the instruction (e.g., via a fetch unit) from the local memory, decoding the instruction (e.g., via an instruction decoder) and generating local memory addresses (e.g., corresponding to an operand), reading the source data, executing or loading/storing operations, and then writing back results.

Host CPU 208 may be associated with host memory 210 and disk 212. In some embodiments, host memory 210 may be an integral memory or an external memory associated with host CPU 208. Host memory 210 may be a local or a global memory. In some embodiments, disk 212 may comprise an external memory configured to provide additional memory for host CPU 208.

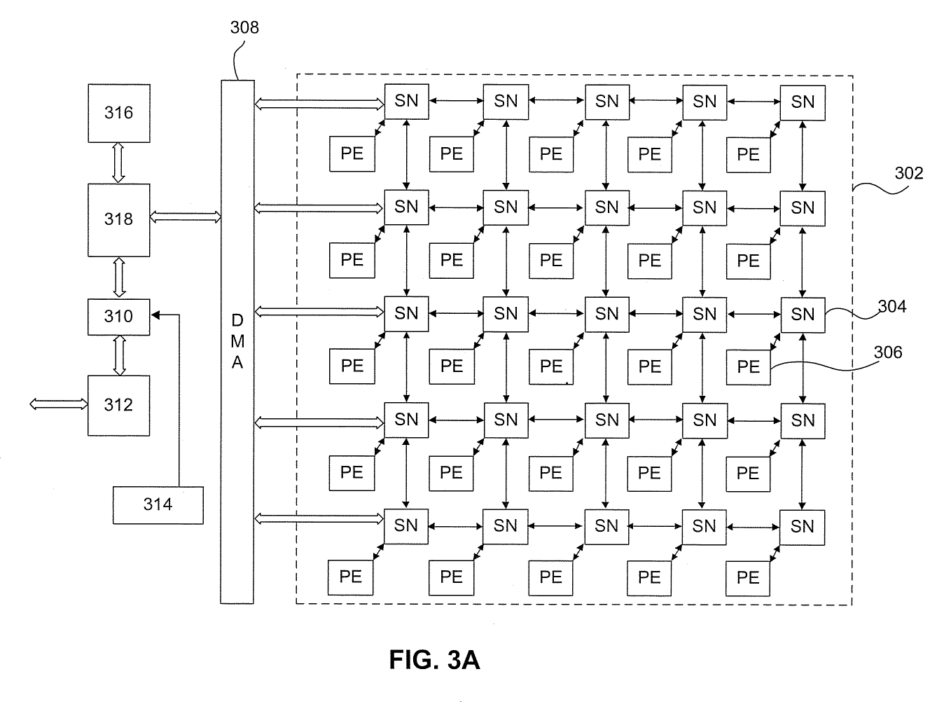

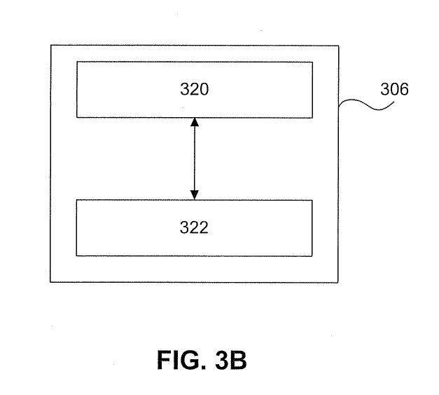

Reference is now made to FIG. 3A, which illustrates an exemplary deep learning accelerator system 300, according to embodiments of the disclosure. Deep learning accelerator system 300 may include a switch network 302 comprising an array of switching nodes 304 and an array of processing elements 306, a DMA unit 308, a host CPU 310 controlled by a control unit 314, a peripheral interface 312, a high bandwidth memory 316, and a high bandwidth memory interface 318. It is appreciated that deep learning accelerator system 300 may comprise other components not illustrated herein.

In some embodiments, switch network 302 may include an array of switch nodes 304. Switch nodes 304 may be arranged in a manner to form a two-dimensional (2D) array of switch nodes 304. In some embodiments, as illustrated in FIG. 3A, switch network 302 may include a switch network comprising a 2D mesh connection of switch nodes such that each switch node 304 in the switch network may be connected with an immediately neighboring switch node 304. Switch node 304 may be configured to route data to and from switch network 302 or within switch network 302. Data may be received internally from another switch node 304 of switch network 302 or externally from DMA unit 308. Routing data may include receiving and transferring data to other relevant components, such as, for example, another switch node 304 or processing element 306 of deep learning accelerator system 300. In some embodiments, switch node 304 may receive data from DMA 308, processing element 306, and one or more neighboring switch nodes 304 of switch network 302.

As illustrated in FIG. 3A, each switch node 304 may be associated with a corresponding processing element 306. Processing element 306 may be similar to processing element 124 of FIG. 1. Deep learning accelerator system 300 may comprise a 2D array of processing elements 306, each processing element connecting with a corresponding switch node 304 of switch network 302. Processing element 306 may be configured to generate data in the form of data packets (described later). In some embodiments, processing element 306 may be configured to generate data based on a computer-executable program, a software, a firmware, or a pre-defined configuration. Processing element 306 may also be configured to send data to a switch node 304.

In some embodiments, switch node 304 may be configured to respond to processing element 306 based on an operating status of switch node 304. For example, if switch node 304 is busy routing data packets, switch node 304 may reject or temporarily push back data packets from processing element 306. In some embodiments, switch node 304 may re-route data packets, for example, switch node 304 may change the flow direction of data packets from a horizontal path to a vertical path, or from a vertical path to a horizontal path, based on the operating status or the overall system status.

In some embodiments, switch network 302 may comprise a 2D array of switch nodes 304, each switch node connecting to a corresponding individual processing element 306. Switch nodes 304 may be configured to transfer data from one location to another, while processing element 306 may be configured to compute the input data to generate output data. Such a distribution of computing and transferring resources may allow switch network 302 to be light-weight and efficient. A light-weight 2D switch network may have some or all of the advantages discussed herein, among others.
(i) Simple switch-based design—The proposed 2D switch network comprises simple switches to control the flow of data within the network. The use of switch nodes enables point-to-point communication between the 2D array of processing elements.
(ii) High computing efficiency—Data flow management including exchanging and transferring data between switch nodes of the network is performed by an executable program such as a software or a firmware. The software allows scheduling dataflow based on dataflow patterns, work load characteristics, data traffic, etc. resulting in an efficient deep learning accelerator system.
(iii) Enhanced performance and low power consumption—The proposed light-weighted switch network relies on de-centralized resource allocation, enabling higher performance of the overall system. For example, computing resources and data storage resources are distributed among an array of processing elements, instead of a central core or processing element hub. The simple mesh-based connections may enable communication between the processing elements.
(iv) Design flexibility and scalability—Software can flexibly divide the workload and data of neural network to the array of processing elements and program the data flow accordingly. This enables adding resources to compute larger volumes of data while maintaining the computing efficiency and the overall system efficiency.
(v) Flexibility of data routing strategies—The proposed 2D switch network may not require complex flow control mechanisms for deadlock detection, congestion avoidance, or data collision management. Because of the mesh network and connectivity, simple and efficient routing strategies may be employed.
(vi) Software compatibility—A software or a firmware may schedule the tasks for processing elements to generate data packets that avoid congestions and deadlocks based on static analysis of the workload, data flow patterns, and data storage, before runtime.

In some embodiments, DMA unit 308 may be similar to DMA unit 108 of FIG. 1. DMA unit 308 may comprise a backbone, and the deep learning accelerator system may include two separate bus systems (e.g., bus 114 of FIG. 1). One bus system may enable communication between the switch nodes 304 of switch network, and the other bus system may enable communication between DMA unit 308 and the backbone. DMA unit 308 may be configured to control and organize the flow of data into and out of switch network 302.

Deep learning accelerator system 300 may comprise host CPU 310. In some embodiments, host CPU 310 may be electrically connected with control unit 314. Host CPU 310 may also be connected to peripheral interface 312 and high bandwidth interface 318. DMA unit 308 may communicate with host CPU 310 or high bandwidth memory 316 through high bandwidth memory interface 318. In some embodiments, high bandwidth memory 316 may be similar to global memory 116 of deep learning accelerator system 100, shown in FIG. 1.

Reference is now made to FIG. 3B, which illustrates a block diagram of an exemplary processing element, according to embodiments of this disclosure. Processing element 306 may comprise a processing core 320 and a memory buffer 322, among other components. Processing core 320 may be configured to process input data received from DMA unit 308 or from another processing element 306 of switch network 302. In some embodiments, processing core 320 may be configured to process input data, generate output data in the form of data packets, and pass generated output data packets to a neighboring processing element 306. Memory buffer 322 may comprise local memory, global shared memory, or combinations thereof, as appropriate. Memory buffer 322 may be configured to store input data or output data.

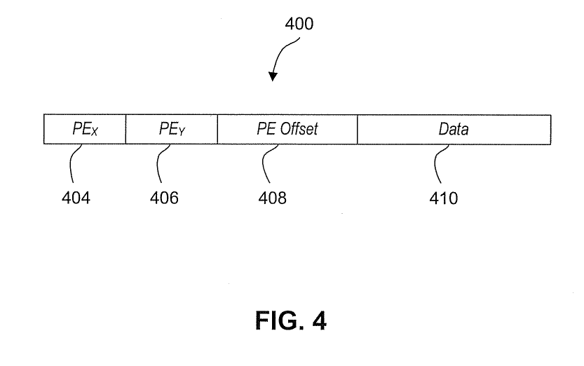

Reference is now made to FIG. 4, which illustrates an exemplary data packet, according to embodiments of the present disclosure. Data packet 400 may be formatted to contain information associated with the destination location and data itself. In some embodiments, data packet 400 may comprise information related to a destination location and data 410 to be transferred to the destination location. The information related to destination location may comprise (X, Y) coordinates of destination processing element 306 in the switch network, and data offset. In some embodiments, PE_{X} may comprise X-coordinate 404 of the destination processing element 306, PE_{Y} may comprise Y-coordinate 406 of the destination processing element 306, and PE_{OFFSET} may comprise information associated with the location within memory buffer 322 of processing element 306. For example, if memory buffer 322 is a 256-bit memory and each line in the memory is 32 bits, then the memory has 8 lines. In such a configuration, PE_{OFFSET} information may indicate the destination line number within the memory to which data 410 belongs. Data packet 400 may be routed by switch nodes 304 within switch network, using one or more routing strategies based on data traffic, data transfer efficiency, type of data shared, etc. Some examples of routing strategies for data are discussed herein. It is appreciated that other routing strategies may be employed, as appropriate.

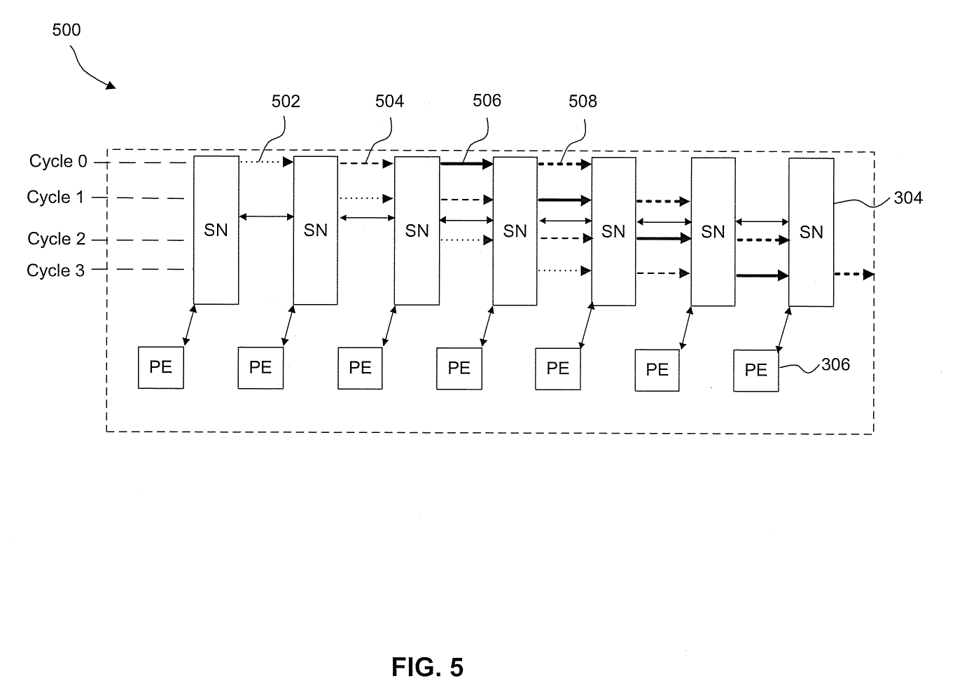

FIG. 5 illustrates an exemplary path 500 for data transfer in a deep learning accelerator system, according to embodiments of the disclosure. Transferring data along transfer path 500 may comprise transferring data packets 502, 504, 506, and 508 horizontally, as illustrated in FIG. 5. Data packets 502, 504, 506, and 508 may be formatted in a similar manner as data packet 400 illustrated in FIG. 4. While only four data packets are illustrated, a deep learning accelerator system may comprise any number of data packets necessary for data computing. The computing workload of a deep learning accelerator system may be divided and assigned to processing elements 306.

In some embodiments, a horizontal pipelined data transfer, as illustrated in FIG. 5, refers to transfer of data or data packets containing data (e.g., data 410 of FIG. 4) from switch node 304 having (X, Y) coordinate, to switch node 304 having (X+i, Y) coordinate in the switch network, where “i” is a positive integer. In some embodiments, the destination switch node 304 may have (X−i, Y) coordinates. The movement of data packets may be from left to right or from right to left, depending on the destination switch node.

As an example, FIG. 5 illustrates a data transfer route for four data packets (e.g., data packet 502, 50, 506, and 508—each annotated in the figure with a different line format). The destination location for each data packet is (X+4, Y). This can be accomplished in four cycles, referred to as cycle 0, cycle 1, cycle 2 and cycle 3. Each cycle may only move a data packet by one switch node 304. In some embodiments, the number of cycles required to move data packets to the destination switch node may equal the number of switch nodes required to transport data packet in a particular direction. In some embodiments, switch nodes 304 in a row along the X-direction or in a column along the Y-direction may be referred to as layers of the deep learning accelerator system.

In some embodiments, processing element 306 associated with switch node 304 may be configured to receive data packet (e.g., data packet 400 of FIG. 4 or 502 of FIG. 5) and store data in memory buffer 322 of processing element 306. The data may be stored within memory buffer 322 based on the PE_{OFFSET} of the received data packet.

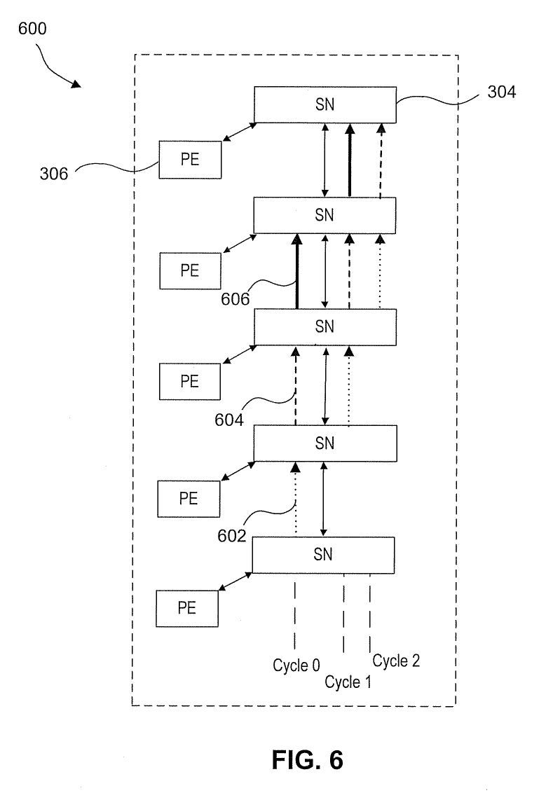

Reference is now made to FIG. 6, which illustrates an exemplary path 600 for data transfer in a deep learning accelerator system, according to embodiments of the disclosure. Transferring data along transfer path 600 may comprise transferring data packets 602, 604, and 606 vertically, as illustrated in FIG. 6. Data packets 602, 604, and 606 may be similar to data packet 400 illustrated in FIG. 4.

In some embodiments, a vertical pipelined data transfer, as illustrated in FIG. 6, refers to transfer of data or data packets containing data (e.g., data 410 of FIG. 4) from switch node 304 having (X, Y) coordinate, to switch node 304 having (X, Y+i) coordinate in the switch network, where “i” is a positive integer. In some embodiments, the destination switch node 304 may have (X, Y−i) coordinates. The movement of data packets may be from bottom to top or from top to bottom, depending on the destination switch node.

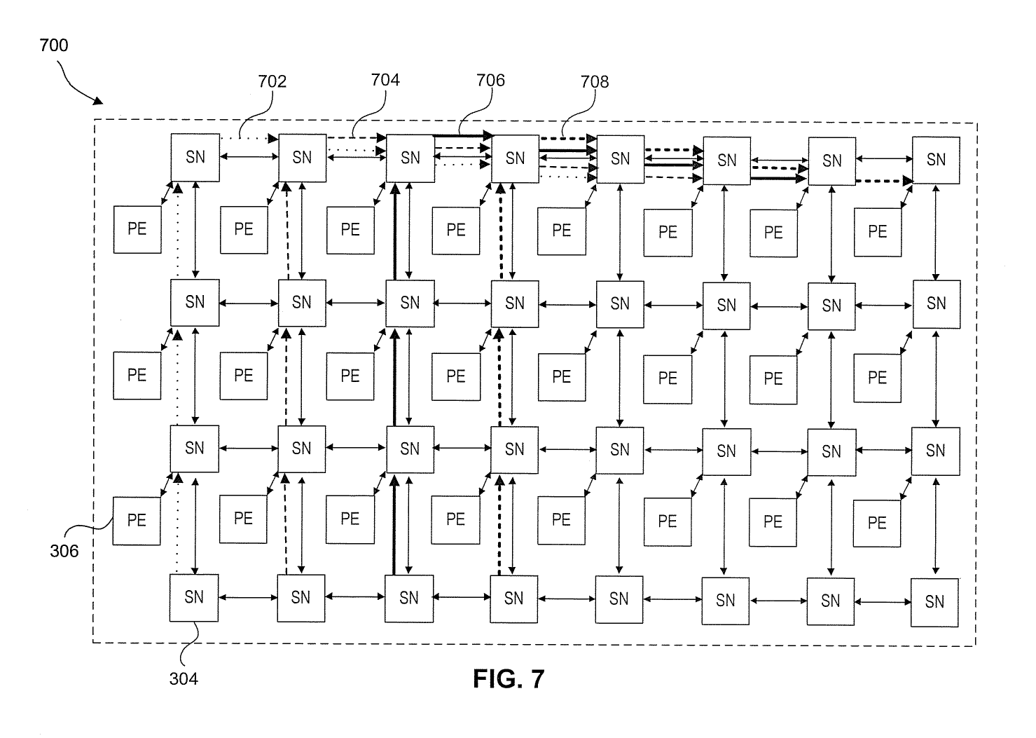

Reference is now made to FIG. 7, which illustrates an exemplary path 700 for data transfer in a deep learning accelerator system, according to embodiments of the disclosure. In some embodiments, processing element 306 of array of processing elements may receive data externally from DMA unit (e.g., DMA unit 308 of FIG. 3A) or other data source. Based on the data received, processing element 306 may generate data packets comprising computing data and destination location information for the computed data. FIG. 7 shows data packets 702, 704, 706, and 708 transferred in both, horizontal and vertical directions. In such a configuration, a two-step process may be employed. In the first step, data packets 702, 704, 706, and 708 may be transferred in the vertical direction along Y-coordinates until destination switch node 304 is reached. Upon reaching the destination Y-coordinate, in the second step, data packets 702, 704, 706, and 708 may be transferred in the horizontal direction along X-coordinates until destination switch node 304 is reached.

In some embodiments, the direction of data flow may be determined by a software before being executed or before runtime. For example, the software may determine a horizontal data flow in a pipelined manner when processing elements 306 generate output data including computation results, and the software may determine a vertical data flow in a pipelined manner when processing elements 306 share input data with their neighboring processing elements.

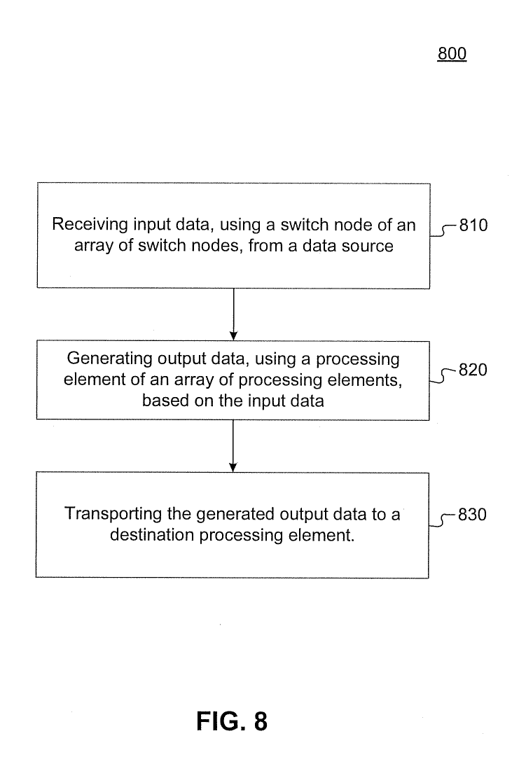

Reference is now made to FIG. 8, which illustrates a process flow chart 800 of an exemplary method to transport data in a deep learning accelerator system (e.g., deep learning accelerator system 100 of FIG. 1), according to embodiments of the disclosure. The method may include receiving data from an internal or external data source using a switch node, generating output data based on the received input data using a processing element, and transporting the output data to a destination processing element.

In step 810, a switch node (e.g., switch node 304 of FIG. 3A) may be configured to receive data from a data source. The data source may be an internal data source, for example, another switch node of the array of switch nodes or a processing element (e.g., processing element 306 of FIG. 3A). In some embodiments, data source may be an external data source, such as, for example, a DMA unit (e.g., DMA unit 308 of FIG. 3A). DMA unit may be configured to control the data flow between a host CPU (e.g., host CPU 310 of FIG. 3A) and a 2D switch network (e.g., switch network 302 of FIG. 3A). In some embodiments, DMA unit may communicate and exchange data with one or more switch nodes 304 of the switch network.

DMA unit may assist with transferring data between a host memory (e.g., local memory of host CPU) and a high bandwidth memory (e.g., high bandwidth memory 316 of FIG. 3A). In addition, DMA unit may be configured to transfer data between multiple processing units. In some embodiments, DMA unit may allow off-chip devices to access both on-chip and off-chip memory without causing a CPU interrupt. Thus, DMA unit may also generate memory addresses and initiate memory read or write cycles. DMA unit may also contain several hardware registers that may be written and read by the one or more processors, including a memory address register, a byte-count register, one or more control registers, and other types of registers.

Switch nodes may be configured to receive input data and transport the received input data or the output data from the processing elements to the destination location within the switch network. The mesh switch network may enable point-to-point data communication between the 2D array of processing elements.

In step 820, a processing element (e.g., processing element 306 of FIG. 3A) may generate output data based on the input data received internally or externally. Mesh switch network may comprise a 2D array of processing elements. Each of the processing elements of the mesh switch network may be associated with at least one switch node. In some embodiments, multiple processing elements may be associated with one switch node, based on the system design and performance requirements.

The processing element may comprise a processor core (e.g., processor core 320 of FIG. 3B) and a memory (e.g., memory buffer 322 of FIG. 3B). The processor core may be configured to compute and generate output data, while the memory buffer may be configured to store the generated output data. In some embodiments, the memory buffer may also store the data and instructions required to compute the output data. The output data may be generated and transported in the form of a data packet (e.g., data packet 400 of FIG. 4). The data packet may be formatted to comprise (X, Y) coordinates of the destination processing element, output data, and the location within the memory buffer of the destination processing element where the data needs to be stored. For example, the data packet may comprise, PE_{X}, PE_{Y}, PE_{OFFSET}, and data. Here, PE_{X} may indicate the X-coordinate of the destination processing element, PE_{Y} may indicate the Y-coordinate of the destination processing element, and PE_{OFFSET} may indicate the bit line address of the memory space in the memory buffer.

The processing element may comprise a local memory or a global shared memory. The local memory of the processing element may be accessed by processor core 320 of the processing element, whereas the global shared memory may be accessed by any processor core of any processing element in the mesh switch network.

In step 830, the generated output data or data packet may be transported to the destination processing element based on the destination information stored in the memory buffer of the processing element. Data may be transported to the destination processing element through one or more routes. The data transportation route may be based on a pre-defined configuration of at the array of switch nodes or the array of processing elements in the mesh switch network. A software, or a firmware, or a computer executable program may determine the route prior to runtime.

In some embodiments, the data or the data packet may be transported along a route determined by statically analyzing at least data flow patterns, or data flow traffic, or data volume, etc. The software (e.g., such as a compiler in a host CPU) may also schedule the tasks for processing elements and program the processing elements to generate data packets that avoid congestion and deadlocks. The determined route may be a horizontal path as shown in FIG. 5, or a vertical path as shown in FIG. 6, or a combination of horizontal and vertical paths as shown in FIG. 7. Other routing strategies may be used, as appropriate.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removeable and nonremovable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the foregoing specification, embodiments have been described with reference to numerous specific details that may vary from implementation to implementation. Certain adaptations and modifications of the described embodiments may be made. Other embodiments may be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art may appreciate that these steps may be performed in a different order while implementing the same method.

In the drawings and specification, there have been disclosed exemplary embodiments. However, many variations and modifications may be made to these embodiments. Accordingly, although specific terms are employed, they are used in a generic and descriptive sense only and not for purposes of limitation, the scope of the embodiments being defined by the following claims.

1. A machine learning accelerator system, comprising:
a switch network comprising:
an array of switch nodes; and
an array of processing elements, wherein each processing element of the array of processing elements is connected to a switch node of the array of switch nodes and is configured to generate data that is transportable via the switch node.

2. The system of claim 1, further comprising a destination switch node of the array of switch nodes and a destination processing element connected to the destination switch node.

3. The system of claim 2, wherein the generated data is transported in one or more data packets, the one or more data packets comprising information related with a location of the destination processing element, a storage location within the destination processing element, and the generated data.

4. The system of claim 3, wherein the information related with the location of the destination processing element comprises (x, y) coordinates of the destination processing element within the array of processing elements.

5. The system of claim 3, wherein a switch node of the array of switch nodes is configured to transport the data packet along a route in the switch network based on a pre-defined configuration of at least one of the array of switch nodes or the array of processing elements.

6. The system of claim 3, wherein the data packet is transported along a route based on an analysis of a data flow pattern in the switch network.

7. The system of claim 5, wherein the route comprises a horizontal path, a vertical path, or a combination thereof.

8. The system of claim 3, wherein a switch node of the array of switch nodes is configured to reject receiving the data packet based on an operation status of the switch node.

9. The system of claim 4, wherein a switch node of the array of switch nodes is configured to modify the route of the data packet based on an operation status of the switch node.

10. The system of claim 1, wherein the processing element comprises:
a processor core configured to generate the data; and
a memory buffer configured to store the generated data.

11. A method of transporting data in a machine learning accelerator system, the method comprising:
receiving input data, using a switch node of an array of switch nodes of a switch network, from a data source;
generating output data, using a processing element that is connected to the switch node and is part of an array of processing elements, based on the input data; and
transporting, using the switch node, the generated output data to a destination processing element of the array of processing elements via the switch network.

12. The method of claim 11, further comprising forming one or more data packets, the one or more data packets comprising information related with a location of a destination processing element within the array of processing elements, a storage location within the destination processing element, and the generated output data.

13. The method of claim 12, further comprising storing the generated output data in a memory buffer of the destination processing element within the array of processing elements.

14. The method of claim 12, comprising transporting the one or more data packets along a route in the switch network based on a pre-defined configuration of the array of switch nodes or the array of processing elements.

15. The method of claim 12, wherein the data packet is transported along a route in the switch network based on an analysis of a data flow pattern in the switch network.

16. The method of claim 14, wherein the route comprises a horizontal path, a vertical path, or a combination thereof.

17. The method of claim 14, wherein a switch node of the array of switch nodes is configured to modify the route of the one or more data packets based on an operation status of the switch node of the array of switch nodes.

18. The method of claim 14, wherein a switch node of the array of switch nodes is configured to reject receiving the data packet based on an operation status of the switch node.

19. A non-transitory computer readable medium storing a set of instructions that is executable by one or more processors of a machine learning accelerator system to cause the machine learning accelerator system to perform a method to transport data, the method comprising:
generating routing instructions for transporting output data generated by a processing element of an array of processing elements based on input data received by the processing element through a switch network to a destination processing element of the array of processing elements, wherein each processing element of the array of processing elements is connected to a switch node of an array of switch nodes of the switch network.

20. The non-transitory computer readable medium of claim 19, wherein the set of instructions that is executable by one or more processors of the machine learning accelerator system cause the machine learning accelerator system to further perform:
forming one or more data packets, the one or more data packets comprising information related with a location of a destination processing element within the array of processing elements, a storage location within the destination processing element, and the generated output data; and
transporting the one or more data packets along a route in the switch network based on a pre-defined configuration of at least one of the array of switch nodes or the array of processing elements.
